(19) United States
(12) Patent Application Publication
(10) Pub. No.: US 2024/0213869 A1
(43) Pub. Date: Jun. 27, 2024

(54) DIRECT DRIVE SYSTEM

(71) Applicant: AAC Microtech (Changzhou) Co., Ltd., Changzhou City, Jiangsu Province (CN)

(72) Inventors: Yu Qin, Shenzhen (CN); Weiling Shi, Shenzhen (CN); Xueyuan Zhu, Shenzhen (CN); Min Chen, Shenzhen (CN)

(21) Appl. No.: 17/915,512

(22) PCT Filed: Jul. 21, 2022
(86) PCT No.: PCT/CN2022/106917

§ 371 Date: Sep. 29, 2022

(30) Foreign Application Priority Data
Jun. 30, 2022 (CN) 202221704292.3

(51) Int. Cl. H02K 41/03

(52) U.S. Cl. CPC H02K 41/031

(57) ABSTRACT

The present disclosure provides direct drive system, including stator, a primary assembly, mover, secondary assembly, and first magnetic yoke. One side of stator being provided with first magnetic yoke. The primary assembly is arranged on first magnetic yoke. The mover has first support surface and second support surface. First support surface and second support surface are arranged on two opposite sides of stator. The secondary assembly is arranged on first support surface. The secondary assembly faces primary assembly, first gap is formed between secondary assembly and primary assembly. A magnetic field loop is formed among secondary assembly, primary assembly, and first magnetic yoke. The side of stator away from first magnetic yoke faces second support surface. Second support surface is to support a work table surface. The direct drive system is reasonable in structure design, can better protect primary assembly and secondary assembly, and has high stability and reliability.

### TECHNICAL FIELD

The present disclosure relates to the technical field of motor drive, and in particular, to a direct drive system.

### BACKGROUND

Direct drive is a direct combination of a new motor with a motion execution part. That is, the motor directly drives a machine to run, without any intermediate mechanical transmission link. Direct drive is applied to a linear moving component with a linear motor as a core driving element and a rotary moving component with a torque motor as a core driving element.

A current direct drive system has the following advantages.

1. In terms of equipment life, the direct drive system reduces mechanical transmission parts, reduces wear and tear, improves the equipment life, and saves energy.

2. The direct drive system eliminates mechanical transmission, which reduces a failure rate and can saves part and manufacturing costs, thereby reducing overall equipment costs.

3. The direct drive system greatly improves equipment machining efficiency and effectively improves machining accuracy. However, the current direct drive system also has the following disadvantages.

In order to form a magnetic field loop between the primary assembly fixed to the stator and the secondary assembly fixed to the mover to cause energized coils of the primary assembly to interact with the magnetic field loop to drive the mover to move along a preset trajectory, magnets for generating a magnetic field are required between a table surface supported by the mover and the stator. However, as the mover is subjected to the pressure of the table surface and moves relative to the stator, the magnets are prone to damage, thereby reducing the reliability of the direct drive system.

### SUMMARY

The present disclosure is intended to provide a new technical solution of a direct drive system, so as to solve at least one of the technical problems existing in the related art.

According to one aspect of the present disclosure, a direct drive system is provided, including a stator, a primary assembly, a mover, a secondary assembly, and a first magnetic yoke; one side of the stator being provided with the first magnetic yoke, the primary assembly being arranged on the first magnetic yoke; the mover having a first support surface and a second support surface, the first support surface and the second support surface being arranged on two opposite sides of the stator respectively, the secondary assembly being arranged on the first support surface, the secondary assembly facing the primary assembly, and a first gap being formed between the secondary assembly and the primary assembly; a magnetic field loop being formed among the secondary assembly, the primary assembly, and the first magnetic yoke;
the side of the stator away from the first magnetic yoke facing the second support surface, the second support surface being used to support a work table surface.

As an improvement, the primary assembly includes a plurality of primary units, the plurality of primary units being distributed on the first magnetic yoke along an extension direction of the first magnetic yoke;
each of the primary units including a coil and an iron core, the iron core being fixed to the first magnetic yoke, and the coil is sleeved on the iron core.

As an improvement, the secondary assembly includes a second magnetic yoke and magnets, an even number of the magnets being arranged on the second magnetic yoke, and two adjacent magnets having different polarity; and
magnetic flux sequentially passes through a first magnet, a first iron core, the first magnetic yoke, a second iron core, a second magnet, and a second steel magnet to flow into the first magnet to form the magnet field loop;
wherein the first magnet is adjacent to the second magnet, and the first iron core is adjacent to the second iron core. As an improvement, the first magnetic yoke includes a preset section extending along a circular arc.

As an improvement, the plurality of primary units are spaced in the preset section, and two adjacent primary units form a preset angle.

As an improvement, the direct drive system further includes a base and a support, the stator being fixed to the support, and the support being fixed to the base.

As an improvement, the direct drive system further includes a limiting assembly, the limiting assembly including a slider and a guide rail;
the guide rail being fixed to the base, the guide rail extending along a distribution direction of the plurality of primary units; the slider being fixed to the mover, the slider being mounted on the guide rail and movable along an extension direction of the guide rail.

As an improvement, the mover is provided with a groove, part of the stator being embedded in the groove, an inner side wall of the groove forming the first support surface;
an outer side wall of the groove forming the second support surface, the first support surface and the second support surface facing a same direction.

As an improvement, a second gap is formed between an inner side wall of the groove opposite the first support surface and the stator.

As an improvement, the slider includes a first chute and a second chute opposite each other, and the guide rail includes a first bulge and a second bulge extending in opposite directions;
the first bulge being correspondingly embedded into the first chute, and the second bulge being correspondingly embedded into the second chute.

One technical effect of the present disclosure is as follows.

In the direct drive system of the present disclosure, the mover has a first support surface and a second support surface, the first support surface and the second support surface are arranged on two opposite sides of the stator respectively, the secondary assembly is arranged on the first support surface, and the second support surface is used to support a work table surface, so that the secondary assembly and the work table surface are arranged on the two opposite sides of the stator respectively. Then, one side of the stator is provided with the first magnetic yoke, and the primary assembly is arranged on the first magnetic yoke. Moreover, the secondary assembly faces the primary assembly, the side of the stator away from the first magnetic yoke faces the second support surface, and a magnetic field loop is formed among the secondary assembly, the primary assembly, and the first magnetic yoke.

As can be seen, the stator has one side on which the magnetic field loop is formed and the other side fixed to the work table surface. Then, components such as magnets for forming the magnetic field loop are not required to be arranged between the stator and the work table surface. Firstly, the direct drive system is reasonable in structure design, and the magnetic field loop is formed in a relatively simple manner, which is convenient for assembly of the components. Secondly, during motion of the mover relative to the stator, damages to the components such as the magnets due to the pressure of the work table surface is prevented, and stability and reliability of the direct drive system are guaranteed. Thirdly, a first gap is formed between the secondary assembly and the primary assembly, which helps to ensure smoothness and stability of the mover driven to move relative to the stator, and also helps to prevent damages of the movement process to the secondary assembly and the primary assembly, so as to further ensure the stability and reliability of the direct drive system.

### BRIEF DESCRIPTION OF DRAWINGS

FIG. 1 is a schematic structural diagram of a direct drive system according to an embodiment of the present disclosure;

FIG. 2 is a schematic structural diagram of the direct drive system according to an embodiment of the present disclosure from another perspective;

FIG. 3 is a schematic diagram of a position relationship between a primary assembly and a secondary assembly of the direct drive system according to an embodiment of the present disclosure;

FIG. 4 is a schematic diagram of a magnetic field loop of the direct drive system according to an embodiment of the present disclosure;

FIG. 5 is a schematic structural diagram of a first chute and a second chute of a slider of the direct drive system according to an embodiment of the present disclosure;

FIG. 6 is a bottom view of the primary assembly of the direct drive system according to an embodiment of the present disclosure;

FIG. 7 is a bottom view of the direct drive system according to an embodiment of the present disclosure;

FIG. 8 is a sectional view taken along a line A-A in FIG. 7;

FIG. 9 is a schematic diagram of a connection relationship between a first steel magnet and a primary unit of the direct drive system according to an embodiment of the present disclosure;

FIG. 10 is a schematic structural diagram of a mover and the secondary assembly of the direct drive system according to an embodiment of the present disclosure; and

FIG. 11 is a schematic diagram of a groove of the mover of the direct drive system according to an embodiment of the present disclosure.

In the drawings, 100. magnetic field loop; 1. stator; 21. primary unit; 211. coil; 212. iron core; 3. mover; 31. first support surface; 32. second support surface; 33. groove; 4. secondary assembly; 41. second magnetic yoke; 42. magnet; 5. first magnetic yoke; 6. support; 71. slider; 711. first chute; 712. second chute; 72. guide rail; 721. first bulge; 722. second bulge; 81. first gap; 82. second gap; 9. base; 10. positioning bulge.

### DESCRIPTION OF EMBODIMENTS

Various exemplary embodiments of the present disclosure are now described in detail below with reference to the accompanying drawings. It is to be noted that, unless otherwise specified, relative arrangement, numerical expressions, and numerical values of components and steps set forth in the embodiments do not limit the scope of the present disclosure.

Embodiments of the present disclosure will be described in detail below. Examples of the embodiments are shown in the accompanying drawings. The same or similar reference numerals indicate the same or similar elements or elements having the same or similar functions. The embodiments described below with reference to the accompanying drawings are illustrative, are used only to explain the present disclosure, and cannot be understood as a limitation on the present disclosure. All other embodiments acquired by those of ordinary skill in the art without creative efforts based on the embodiments in the present disclosure shall fall within the protection scope of the present disclosure.

Features modified by the terms “first” and “second” in the specification and claims of the present disclosure may indicate or implicitly include one or more such features. In the description of the present disclosure, “a plurality of” means two or more than two, unless expressly specified otherwise. In addition, “and/or” in the specification and claims indicates at least one of the connected objects, and the character “/” generally indicates that associated objects before and after it are in an “or” relationship.

In the description of the present disclosure, it is to be understood that the orientation or position relationships indicated by the technical terms “central”, “longitudinal”, “transverse”, “length”, “width”, “thickness”, “upper”, “lower”, “front”, “back”, “left”, “right”, “vertical”, “horizontal”, “top”, “bottom”, “inner”, “outer”, “clockwise”, “counterclockwise”, “axial”, “radial”, “circumferential”, etc. are based on the orientation or position relationships shown in the accompanying drawings and are only intended to facilitate the description of the present disclosure and simplify the description, rather than indicating or implying that the apparatus or element referred to must have a particular orientation or be constructed and operated in a particular orientation, and therefore cannot to be interpreted as limitations on the present disclosure.

In the description of the present disclosure, it is to be noted that, unless specifically stated and limited, the technical terms “mount,” “couple”, and “connect” should be understood in a broad sense, such as, a fixed connection, a detachable connection, or an integral connection; a mechanical connection or an electrical connection; a direct connection, an indirect connection through an intermediate medium, an internal connection of two elements, or an interaction of two elements. For those of ordinary skill in the art, the specific meanings of the above terms in the present disclosure can be understood on case-by-case.

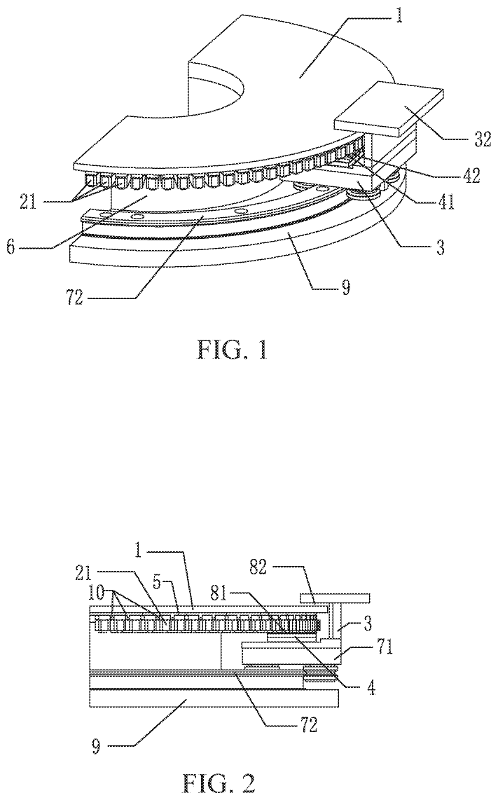

As shown in FIG. 1 to FIG. 11, the present disclosure provides a direct drive system for realizing movement of a work table in accordance with a preset trajectory, for example, in accordance with a linear trajectory. Certainly, a movement trajectory of the work table may also be set according to an actual requirement. The movement trajectory may be, but is not limited to, a linear trajectory.

Specifically, referring to FIG. 1 and FIG. 2, the direct drive system includes a stator 1, a primary assembly, a mover 3, a secondary assembly 4, and a first magnetic yoke 5. The stator 1 is of a fixed structure. The mover 3 is of a movable structure. The mover 3 is driven by the direct drive system to move relative to the stator 1.

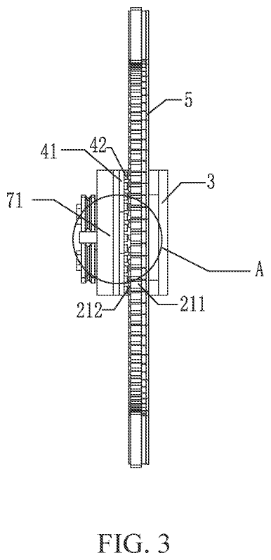

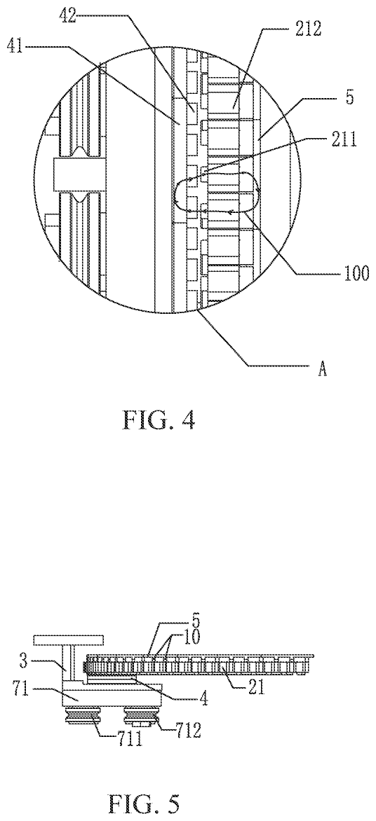

Further specifically, one side of the stator 1 is provided with the first magnetic yoke 5, and the primary assembly is arranged on the first magnetic yoke 5. The mover 3 has a first support surface 31 and a second support surface 32, the first support surface 31 and the second support surface 32 are arranged on two opposite sides of the stator 1 respectively, the secondary assembly 4 is arranged on the first support surface 31, the secondary assembly 4 faces the primary assembly, and a first gap 81 is formed between the secondary assembly 4 and the primary assembly. A magnetic field loop 100 is formed among the secondary assembly 4, the primary assembly, and the first magnetic yoke 5. Refer to FIG. 3 and FIG. 4 for the magnetic field loop 100.

The side of the stator 1 away from the first magnetic yoke 5 faces the second support surface 32, and the second support surface 32 is used to support a work table surface, so that the work table surface is driven by the mover 3 to move in accordance with the preset trajectory.

In the direct drive system of the present disclosure, the mover 3 has a first support surface 31 and a second support surface 32, the first support surface 31 and the second support surface 32 are arranged on two opposite sides of the stator 1 respectively, the secondary assembly 4 is arranged on the first support surface 31, and the second support surface 32 is used to support a work table surface, so that the secondary assembly 4 and the work table surface are arranged on the two opposite sides of the stator 1 respectively. Then, one side of the stator 1 is provided with the first magnetic yoke 5, and the primary assembly is arranged on the first magnetic yoke 5. Moreover, the secondary assembly 4 faces the primary assembly, the side of the stator 1 away from the first magnetic yoke 5 faces the second support surface 32, and a magnetic field loop 100 is formed among the secondary assembly 4, the primary assembly, and the first magnetic yoke 5.

As can be seen, the stator 1 has one side on which the magnetic field loop 100 is formed and the other side fixed to the work table surface. Then, components such as magnets 42 for forming the magnetic field loop 100 are not required to be arranged between the stator 1 and the work table surface. Firstly, the direct drive system is reasonable in structure design, and the magnetic field loop 100 is formed in a relatively simple manner, which is convenient for assembly of the components. Secondly, during motion of the mover 3 relative to the stator 1, damages to the components such as the magnets 42 due to the pressure of the work table surface are prevented, and stability and reliability of the direct drive system are guaranteed. Thirdly, a first gap 81 is formed between the secondary assembly 4 and the primary assembly, which helps to ensure smoothness and stability of the mover 3 driven to move relative to the stator 1 and also helps to prevent damages of the movement process to the secondary assembly 4 and the primary assembly, so as to further ensure the stability and reliability of the direct drive system.

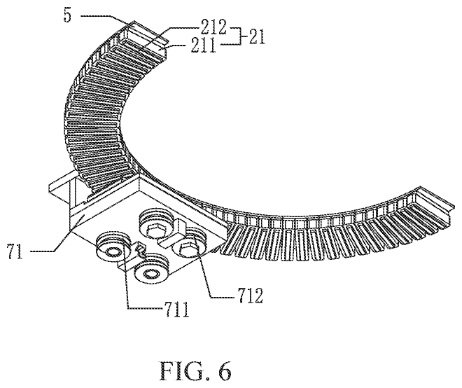

Optionally, referring to FIG. 6 and FIG. 9, the primary assembly includes a plurality of primary units 21, and the plurality of primary units 21 are distributed on the first magnetic yoke 5 along an extension direction of the first magnetic yoke 5.

Each of the primary units 21 includes a coil 211 and an iron core 212, the iron core 212 is fixed to the first magnetic yoke 5, and the coil 211 sleeves the iron core 212.

It is to be noted that adjacent primary units 21 are spaced. The first magnetic yoke 5 may extend according to a movement direction of the mover 3, so that the plurality of primary units 21 distributed along an extension direction of the first magnetic yoke 5 can better mate with secondary units on the mover 3 to form the magnetic field loop 100, which ensures that the mover 3 can move more smoothly under interaction between the magnetic field loop 100 and the primary assembly.

In the above embodiment, the structure of the primary units 21 and distribution of the plurality of primary units 21 are simplified, the structure of the direct drive system is optimized, and stability of connection between the primary assembly and the first magnetic yoke 5 is also improved.

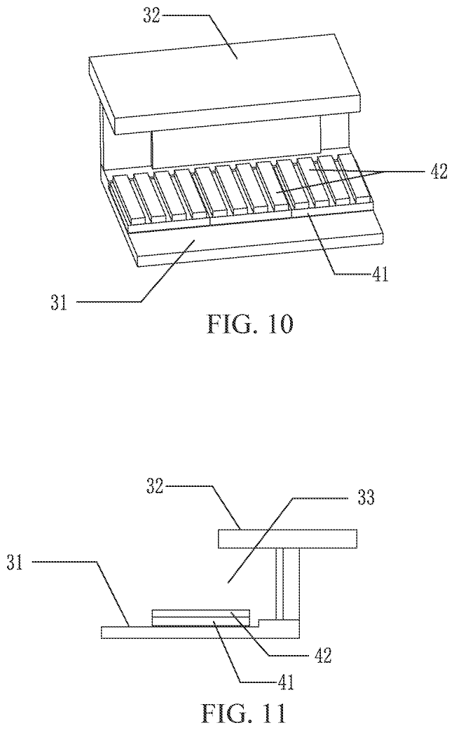

Optionally, referring to FIG. 10 and FIG. 11, the secondary assembly 4 includes a second magnetic yoke 41 and magnets 42, an even number of the magnets 42 are arranged on the second magnetic yoke 41, and two adjacent magnets 42 have different polarity. For example, the magnets 42 may be steel magnets with magnetic properties. The even number of the magnets 42 are provided to ensure that the magnetic field loop 100 can be formed among the primary assembly, the secondary assembly 4, and the first magnetic yoke 5 during movement of the mover 3.

Magnetic flux sequentially passes through the first magnet 42, a first iron core 212, the first magnetic yoke 5, a second iron core 212, a second magnet 42, and a second steel magnet to flow into the first magnet 42 to form the magnet field loop 100. The first magnet 42 is adjacent to the second magnet 42, and the first iron core 212 is adjacent to the second iron core 212.

In the above embodiment, the magnet field loop 100 is located on the side of the stator 1 away from the work table surface, and the magnet field loop 100 is formed in a relatively reasonable manner, which reduces consumption of the magnets 42, helps to save costs, and also helps to simplify the structure of the secondary assembly 4. At the same time, the stator 1 can also better move under a joint action of the coil 211 and the magnet field loop 100.

Optionally, the first magnetic yoke 5 includes a preset section extending along a circular arc. The first magnetic yoke 5 has a preset section extending along a circular arc, and then the plurality of primary units 21 are distributed along the arc-shaped preset section, so that the secondary units on the mover 3 mate with the primary units 21 to cause the mover 3 to move along an arc-shaped trajectory, which better enables the mover 3 to drive the work table to move along the arc-shaped trajectory and makes a movement manner relatively simple.

Optionally, the plurality of primary units 21 are spaced in the preset section, and two adjacent primary units 21 form a preset angle.

In the above embodiment, a stable magnetic field loop 100 can be formed between the secondary units, the primary units 21, and the first steel magnet, so as to ensure that the mover 3 drives the work table to move more stably along the arc-shaped trajectory.

Optionally, the direct drive system further includes a base 9 and a support 6, the stator 1 is fixed to the support 6, and the support 6 is fixed to the base 9.

In the above embodiment, the support 6 can better fix the stator 1, while the base 9 helps to fix the stator 1 stably at a preset position.

Optionally, the direct drive system further includes a slider 71 and a guide rail 72.

The guide rail 72 is fixed to the base 9, the guide rail 72 extends along a distribution direction of the plurality of primary units 21. The slider 71 is fixed to the mover 3, and the slider 71 is mounted on the guide rail 72 and movable along an extension direction of the guide rail 72.

In the above embodiment, the guide rail 72 extends along a distribution direction of the plurality of primary units 21, which helps to realize that the mover 3 can better mate with the primary assembly during the movement, so as to easily realize the magnetic field loop 100 and drive the mover 3 to move more stably.

In addition, the guide rail 72 mates with the slider 71, which helps to accurately guide a movement direction of the mover 3, and also helps to reduce movement resistance, so that the mover 3 can drive the work table to move accurately and stably along the preset trajectory.

Optionally, referring to FIG. 1 and FIG. 11, the mover 3 is provided with a groove 33, part of the stator 1 is embedded in the groove 33, and an inner side wall of the groove 33 forms the first support surface 31.

An outer side wall of the groove 33 forms the second support surface 32, and the first support surface 31 and the second support surface 32 face to a same direction.

In the above embodiment, the structure of the mover 3 is reasonably designed, which can effectively prevent the arrangement of the magnets 42 such as steel magnets between the work table surface and the stator 1, greatly reduces consumption of the steel magnets, can also optimize the structure of the secondary assembly 4, and better reduces costs.

Optionally, a second gap 82 is formed between an inner side wall of the groove 33 the first support surface 31 and the stator 1. In this way, only a motion gap exists between the work table surface and the stator 1, and no steel magnet exists between the work table surface and the stator 1, so that the reliability is higher. At the same time, the mover 3 can also move more stably relative to the stator 1.

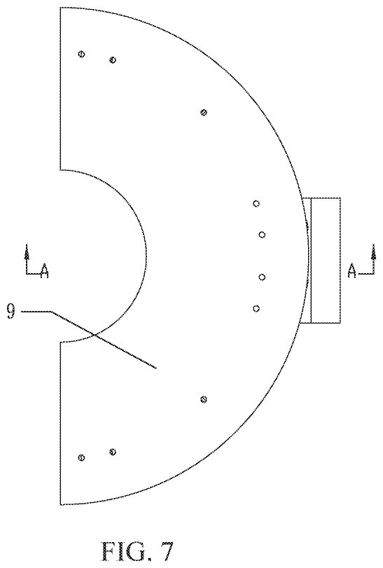

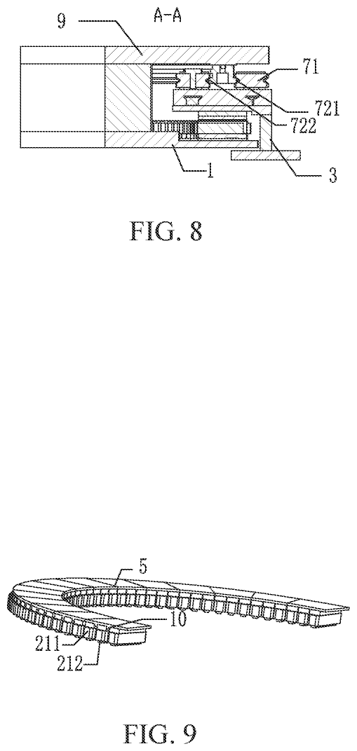

Optionally, referring to FIG. 5 and FIG. 6, the slider 71 includes a first chute 711 and a second chute 712 opposite each other. Referring to FIG. 7 and FIG. 8, the guide rail 72 includes a first bulge 721 and a second bulge 722 extending in opposite directions.

The first bulge 721 is correspondingly embedded into the first chute 711, and the second bulge 722 is correspondingly embedded into the second chute 712.

In the above embodiment, the first bulge 721 is correspondingly embedded into the first chute 711, and the second bulge 722 is correspondingly embedded into the second chute 712, which can accurately limit the mover 3, and also help to ensure stability of the mover 3 during the movement.

It is to be noted that the current direct drive system is provided with steel magnets between the stator 1 and the work table surface, which increases consumption of the steel magnets and costs on the one hand. On the other hand, the mover 3 easily damages the steel magnets during movement, thereby reducing stability of the direct drive system.

However, the technical solution of the present disclosure can better solve the problems existing in the related art, in which the magnetic field loop 100 can be formed between the secondary assembly 4, the primary assembly, and the first magnetic yoke 5 without the arrangement of the magnets 42 such as steel magnets between the work table surface and the stator 1. That is, magnetic flux flows from the secondary assembly 4 to the primary assembly and then back to the secondary assembly 4, so as to form a loop. Therefore, the direct drive system according to the embodiment of the present disclosure enables the mover 3 to move according to the preset trajectory, which greatly reduces the costs of the direct drive system, optimizes the structure of the direct drive system, and ensures stability and reliability of the whole direct drive system.

In some embodiments, the primary units 21 are stably fixed to the first magnetic yoke 5 by an assembly fixture. The assembly is relatively simple, which helps to quickly realize the fixation between the primary assembly and the first magnetic yoke 5.

In some other embodiments, referring to FIG. 1, positioning bulges 10 are spaced on a surface of the first magnetic yoke 5 facing the primary units 21, at least one primary unit 21 is arranged between two adjacent positioning bulges 10, so as to realize the positioning of the primary units 21, which helps to quickly and accurately mount the primary units 21 on the first magnetic yoke 5.

Based on the above, the direct drive system according to the present disclosure is reasonable in structure design, can better protect the primary assembly and the secondary assembly 4, and has high stability and reliability.

It may be understood that the above embodiments are only exemplary embodiments intended to illustrate the principle of the present disclosure, but the present disclosure is not limited thereto. For those of ordinary skill in the art, various variations and improvements can be made without deviating from the spirit and essence of the present disclosure, and these variations and improvements are also regarded as the protection scope of the present disclosure.

What is claimed is:

1. A direct drive system, comprising a stator, a primary assembly, a mover, a secondary assembly, and a first magnetic yoke; wherein
the first magnetic yoke is provided at a side of the stator, and the primary assembly is arranged on the first magnetic yoke;
the mover comprises a first support surface and a second support surface, and the first support surface and the second support surface are arranged on two opposite sides of the stator respectively, the secondary assembly is arranged on the first support surface, the secondary assembly faces the primary assembly, and a first gap is formed between the secondary assembly and the primary assembly;
a magnetic field loop is formed among the secondary assembly, the primary assembly, and the first magnetic yoke; and
a side of the stator away from the first magnetic yoke faces the second support surface, and the second support surface is used to support a work table surface.

2. The direct drive system as described in claim 1, wherein
the primary assembly comprises primary units, the primary units are distributed on the first magnetic yoke along an extension direction of the first magnetic yoke;
each of the plurality of primary units comprises a coil and an iron core, the iron core is fixed to the first magnetic yoke, and the coil is sleeved on the iron core.

3. The direct drive system as described in claim 2, wherein the secondary assembly comprises a second magnetic yoke and magnets, an even number of the magnets is arranged on the second magnetic yoke, and two adjacent magnets have different polarities; and
magnetic flux sequentially passes through a first magnet, a first iron core, the first magnetic yoke, a second iron core, a second magnet, and a second steel magnet to flow into the first magnet to form a magnet field loop;
wherein the first magnet is adjacent to the second magnet, and the first iron core is adjacent to the second iron core.

4. The direct drive system as described in claim 2, wherein the first magnetic yoke comprises a preset section extending along a circular arc.

5. The direct drive system as described in claim 4, wherein the primary units are spaced in the preset section, and two adjacent primary units the primary units form a preset angle.

6. The direct drive system as described in claim 1, further comprising a base and a support, wherein the stator is fixed to the support, and the support is fixed to the base.

7. The direct drive system as described in claim 6, further comprising a limiting assembly, wherein the limiting assembly comprises a slider and a guide rail; and
the guide rail is fixed to the base, the guide rail extends along a distribution direction of the primary units;
the slider is fixed to the mover, the slider is mounted on the guide rail and movable along an extension direction of the guide rail.

8. The direct drive system as described in claim 7, wherein the mover is provided with a groove, part of the stator is embedded in the groove, an inner side wall of the groove forms the first support surface;
an outer side wall of the groove forms the second support surface, the first support surface and the second support surface face a same direction.

9. The direct drive system as described in claim 8, wherein a second gap is formed between an inner side wall of the groove opposite to the first support surface and the stator.

10. The direct drive system as described in claim 7, wherein the slider comprises a first chute and a second chute opposite to each other, and the guide rail comprises a first bulge and a second bulge extending in an opposite direction;
the first bulge is correspondingly embedded into the first chute, and the second bulge is correspondingly embedded into the second chute.
